(19) United States
(12) Patent Application Publication
(10) Pub. No.: US 2012/0225297 A1
(43) Pub. Date: Sep. 6, 2012

(54) GAS/PLASMA SPRAY COATING

(75) Inventors: Mark P. Birka, Northville, MI (US); Timothy F. O'Brien, white Lake, MI (US); Judson H. Whiteside, Thornhill (CA)

(73) Assignee: Magna International Inc., Aurora (CA)

(21) Appl. No.: 13/365,526

(22) Filed: Feb. 3, 2012

Related U.S. Application Data
(60) Provisional application No. 61/462,634, filed on Feb. 4, 2011.

(51) Int. Cl. B32B 27/06; B32B 15/04; B32B 18/00; B05D 1/12; B32B 17/06

(52) U.S. Cl. 428/412; 427/446; 428/426; 428/446; 428/432; 428/450

(57) ABSTRACT

A plasma spray process used for coating surfaces of a variety of components made of a plastic substrate. Powder particles are injected into a plasma jet where they soften and then strike the surface at high velocity to produce a strongly adherent coating. The component or work piece the coating is being applied to remains cool because the plasma is localized at the plasma gun. The plasma spray process allows for the melting of glass particles, creating a transfer mechanism to the plastic substrate. Components having complex shapes can be coated, without the issues currently encountered in dip coating. The powder coating is applied via plasma spraying, as a protective layer, giving glass like surface properties to a component having complex molded or formed shapes.

### CROSS-REFERENCE TO RELATED APPLICATIONS

This application claims the benefit of U.S. Provisional Application No. 61/462,634, filed Feb. 4, 2011.

### FIELD OF THE INVENTION

The present invention relates to a ceramic or glass coating applied to a surface using a plasma spraying process, where the coating is made from powder particles.

### BACKGROUND OF THE INVENTION

It is common for plastic surfaces to be coated with a protective layer to prevent the plastic surface from being susceptible to abrasions. This allows for a component to have the lightweight and formability properties of a plastic material but also resistant to abrasions in the same manner as glass. The plastic surface may consist of a common plastic (polycarbonate). The component having the plastic surface may be an exterior panel of an automobile, an interior panel, window, windshield, sunroof or moonroof of an automobile or other transportation vehicle. Typically, these types of components are resin coated using a dip coating process or wet coating process.

One of the drawbacks to current dip coating processes is the cure time to finish the part. Also, dip coating does not always provide for a uniform distribution of the coating on the part (coating thickness gradient results). If the part has a complex shape, or includes one or more apertures, the coating flows around the part as it cures, causing the final coating to be of an uneven thickness, and potential cosmetic defects. Additionally, dip coating is also expensive, as is creating a hard coated polycarbonate.

Additionally, dip coatings may require oven curing steps. Heating of the underlying part will sometimes cause warping of the part. This results in higher scrap rates and reduces production efficiencies.

Accordingly, there exists a need for a coating which is inexpensive to manufacture, provides glass-like surface properties, and has an acceptable manufacturing characteristics.

### SUMMARY OF THE INVENTION

The present invention is directed to a plasma spray process used for coating surfaces of a variety of components. Plasma is the term used to describe gas which has been raised to such a high temperature that it ionizes and becomes electrically conductive. In the case of plasma spraying with regard to the present invention, the plasma is created by an electric arc burning within the nozzle of a plasma gun, and the arc gas is formed into a plasma jet as it emerges from the nozzle. Powder particles are injected into the plasma jet where they soften and then strike the surface at high velocity to produce a strongly adherent coating. The component or work piece that the coating is being applied to remains cool because the heat generated by the creation of the plasma is localized at the plasma gun.

The plasma spray process of the present invention allows for the melting of powder glass particles, creating a transfer mechanism to the plastic substrate. Components having complex shapes can be coated, without the issues currently encountered in dip coating. As the material used for creating the glass particles can be a reclaimed product from other manufacturing processes, the cost of coating material is greatly reduced (versus current wet coating technologies). Cure time for the applied plasma is much shorter than wet coats, providing additional cost savings.

In one embodiment, the powder particles are reclaimed glass powder from mirror manufacturing, or other sources, to be applied to a component having a surface in which it is desired that the surface have a glass finish. The component is a molded or formed transparency, may be made of polycarbonate, acrylic materials, or other elastomer. The powder coating is applied via plasma spraying, as a protective layer, giving glass like surface properties to a component having complex molded or formed shapes.

It is an object of the present invention to use reclaimed glass powder to provide a low-cost hardcoat solution for elastomeric transparencies. It is another object of the invention to provide a moldable or formable transparent substrate, with lower mass than a homogenous glass solution, with surface properties of glass.

In one aspect of the present invention, the reclaimed glass basically replaces metallic ingots found in typical plasma depostion. The component or panel being coated provides a formable shape that becomes a plastic carrier for the plasma applied glass.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a plasma gun used for applying particles of a powder to a surface of a component using a plasma spraying process, according to the present invention;

FIG. 2 is a sectional view of a component having a coating applied using a plasma spraying process, according to the present invention;

FIG. 3 is a component having a coating applied using a plasma spray process, according to the present invention;

FIG. 4 is a component mounted to a vehicle, where the component has a coating applied using a plasma spray process, according to the present invention;

FIG. 5 is a component mounted to a high speed train where the component is a window for a high speed train;

FIG. 6A is an alternate embodiment the invention where the component is coated duct work for a furnace;

FIG. 6B is a cross-sectional view of the component of 6A; and

FIG. 7 is a schematic view of the plasma spraying process.

### DETAILED DESCRIPTION OF THE PREFERRED EMBODIMENTS

The following description of the preferred embodiment(s) is merely exemplary in nature and is in no way intended to limit the invention, its application, or uses.

A plasma gun 10, shown generally, used as part of a plasma spraying process according to the present invention is shown in FIG. 1. The plasma gun 10 includes a cathode 12 and nozzle 14, where the nozzle 14 functions as an anode. The cathode 12 and nozzle 14 are used to create an electric arc, and as an inert gas passes through the arc, the inert gas is heated, forming a plasma gas, shown generally at 16, which exits out of an aperture 18 formed as part of the nozzle 14, in the form of a gas stream.

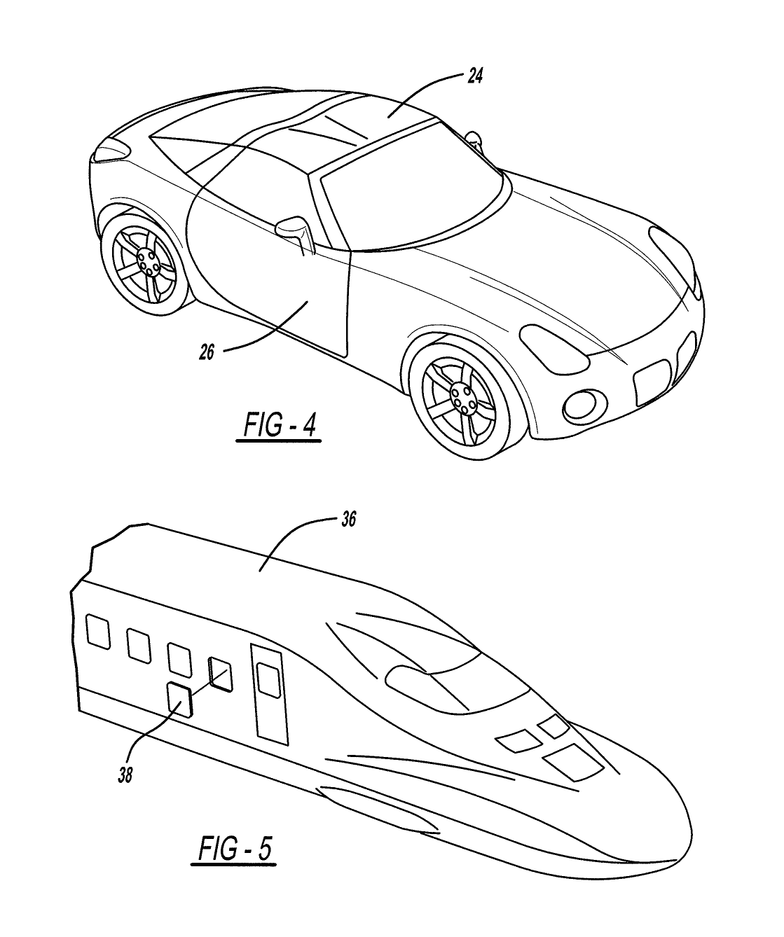

Referring now to FIGS. 1-4, particles in a powder form are injected into the gas stream forming a spray, generally shown at 20. The particles soften due to the exposure to the plasma gas 16 (which is at a high temperature) coming out of the nozzle 14, and the spray 20 contacts a surface 22 of a component 24 that is being coated. The spray 20, which is liquefied powder, in the form of liquid ceramic or glass instantaneously solidifies when it comes into contact with the component 24. During the process shown in FIG. 1, it is necessary to control and maintain an optimum distance 11. As used herein optimum distance is defined as the distance between the component 24 and plasma gun 10 where the liquid ceramic or glass in the spray 20 will instantaneously solidify when it comes into contact with the surface of component 24. If the distance is too close, the liquid ceramic or glass material will not instantaneously solidify onto the component surface and can result in inconsistencies in thicknesses or leave undesirable streak marks on the component 24. If the distance is too great, the liquid ceramic or glass will solidify prior to coming into contact with the component 24 and will simply make contact with the component 24 and fall off. The optimum distance 11 can depend on several factors including temperature of the plasma, the composition of the spray 20 or material being used, the temperature of the component 24 or ambient air, and the shape of the component 24, which can have contours, corners or sides that will require the component 24 or plasma gun 10 to be adjusted to the optimum distance during the spraying process. In the present embodiment of the invention, the component 24 is a convertible hard top for a vehicle 26. In alternate embodiments, the component 24 may be a sun roof, moon roof, a quarter glass component, or a backlight for a sport utility vehicle. It is also within the scope of the invention that the surface 22 may be part of a B-pillar or D-pillar appliqué of a vehicle.

The component 24 has the surface 22 mentioned above, as well as a second surface 28 which may be coated as well. The spray 20 forms a coating 30 which may be applied to both surfaces 22, 28 if desired.

The substantial temperature difference between the plasma gas 16 and the atmosphere causes the particles in the spray 20 to return to solid form and adhere almost instantaneously after contacting the surfaces 22,28. The coating 30 on the surfaces 22, 28 prevents the surfaces 22, 28 from becoming scratched, or easily sustaining other abrasions.

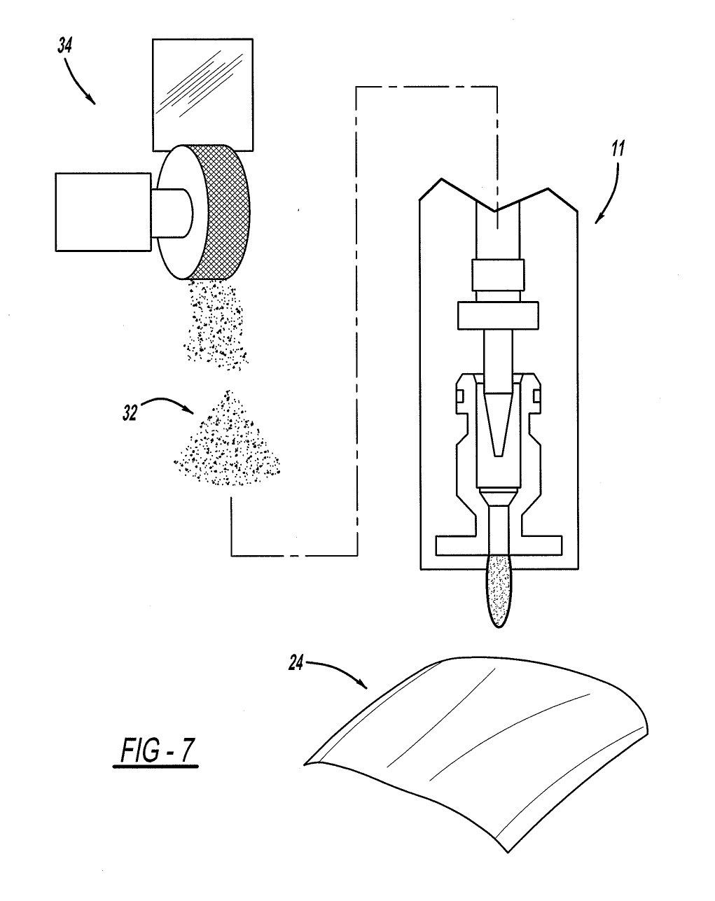

Referring to FIG. 7, a schematic diagram of an embodiment of the invention depicting a process for using reclaimed materials is depicted. Reclaimed material in the form of powder 32 is obtained from a variety of sources. For example, the powder 32 is glass, silica or ceramic and can be ground into powder form from stock materials or can be reclaimed from another process 34 such as mirror grinding where powdered glass is formed from a grinding wheel contacting a mirror. The reclaimed powder 32 is gathered and used in the plasma spraying process 11 (shown in greater detail in FIG. 1). The plasma spray process 11 is then used to coat the surface of the component 24 (shown in greater detail in FIG. 3). The plasma spraying process 11 described above provides a further advantage because it allows for the reclaimed powder 32, which was previously discarded or disposed of at a waste facility, to now be used as the powder material for an entirely different process. This provides the advantage of eliminating waste generated from another process 34 and using it in the plasma spray process in accordance with the present invention.

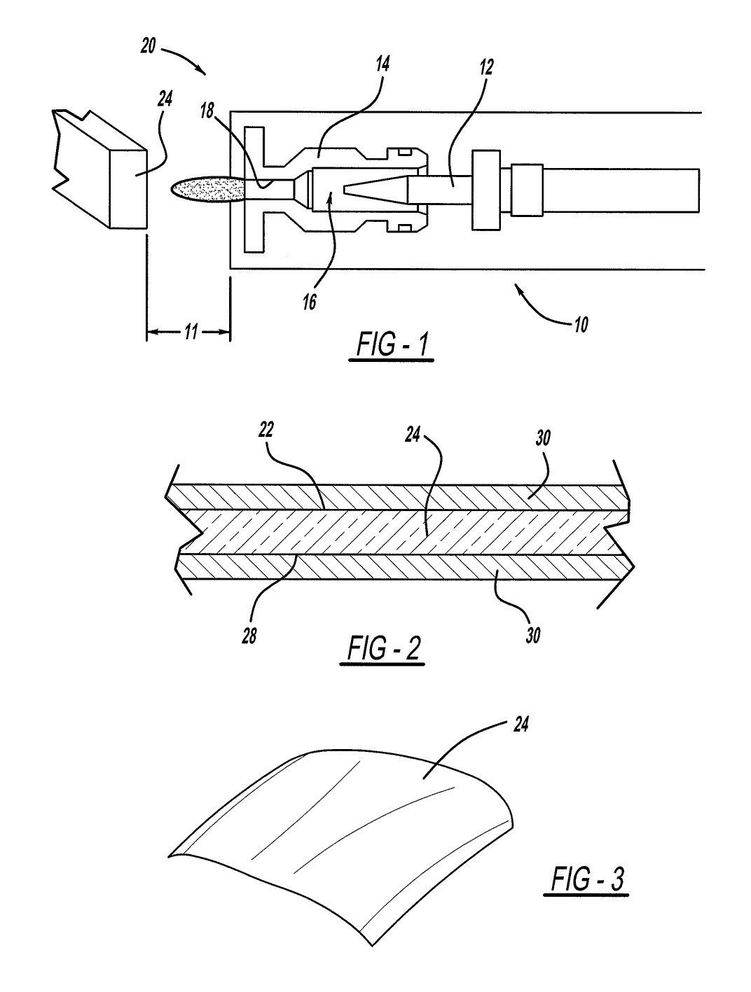

FIG. 5 depicts a schematic view of an alternate component formed using the process described in the present invention. As shown in FIG. 5, a high speed train has a component 38, which is a window formed of polycarbonate material that is coated in the same process described in FIGS. 1 and 2 above. High speed trains 36 generally have large windows, which when made of glass, add a significant amount of weight to the high speed train. It is desirable to form components of the high speed train 36 out of durable lighter weight material in order to make the high speed train 36 lighter and able to transport more cargo or passengers.

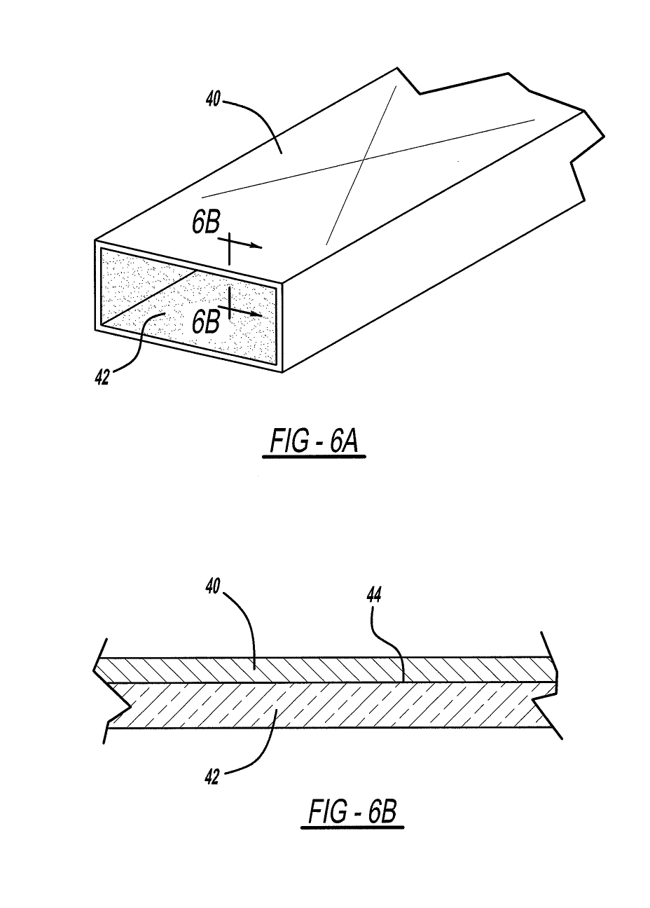

FIG. 6A depicts an embodiment of the present invention incorporated into a component which is a furnace duct 40. The furnace duct 40 has its inside surface sprayed with a coating 42 that is applied using the plasma spraying process described in FIG. 1. The coating 42 is also shown in FIG. 6B which shows a layer of coating 42 applied to an inside surface 44 of the furnace duct 40. The coating 42 is ceramic material, which provides heat conducting attributes that minimize heat loss as air flows through the furnace duct 40. While the coating 42 is described as ceramic, it is within the scope of this invention for other materials to be used. The furnace duct 40 in this particular application is not plastic and is formed of metal, such as aluminum or steel; therefore it is within the scope of this invention for the process shown in FIG. 1 to be used to apply a coating to a component that is made of metal.

The coating 30 formed on the surfaces 22, 28 is generally from about 5-40 μm thick, typically 10-30 μm, and is preferably 20-30 μm thick, depending on what type of part is being coated, and the thickness desired.

The coating and process of the present invention provides for more uniform coating thicknesses. Heat cure is not required, reducing or eliminating losses due to warpage. Glass-like abrasion resistance and transparency is achieved in a lightweight polymer part of complex shape.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A plasma spray process for coating a surface, comprising the steps of:
providing a plasma gun having a nozzle and a cathode;
providing a surface of a component being located at an optimum distance to said plasma gun;
creating an electric arc with said nozzle and said cathode;
creating a plasma gas stream by injecting an inert gas into said nozzle;
injecting a plurality of particles of a powder into said plasma gas stream to form a spray;
contacting said surface of said component with said spray such that as said plurality of particles contact said surface of said component, said plurality of particles adhere to said surface of said component.

2. The plasma spray process for coating a surface of claim 1, further comprising the steps of softening said plurality of particles of powder as said plurality of particles is injected into said plasma gas stream.

3. The plasma spray process for coating a surface of claim 1, further comprising the steps of providing said powder to be glass or ceramic particles.

4. The plasma spray process for coating a surface of claim 1, further comprising the steps of providing said surface of said component to be one selected from the group consisting of polycarbonate, an elastomer, an acrylic material, and a molded transparency.

5. The plasma spray process for coating a surface of claim 1, further comprising the steps of providing said powder to be made from reclaimed glass powder.

6. A plasma spray process for coating a surface, comprising the steps of:
providing a plasma gun having a nozzle and a cathode;
providing a surface of a component being at an optimum distance to said plasma gun, wherein said component is one selected from the group comprising an interior panel, window, windshield, sunroof or moon roof of a transportation vehicle or a metal surface of a furnace duct;
creating an electric arc with said nozzle and said cathode;
creating a plasma gas stream by injecting an inert gas into said nozzle;
injecting a plurality of particles of powder into said plasma gas stream to form a spray; and
contacting said surface of said component with said spray such that said plurality of particles adhere and solidify upon contacting said surface of said component.

7. The plasma spray process for coating a surface of claim 6, further comprising the steps of softening said plurality of particles of powder as said plurality of particles is injected into said plasma gas stream.

8. The plasma spray process for coating a surface of claim 6, further comprising the steps of providing said powder to be glass or ceramic particles.

9. The plasma spray process for coating a surface of claim 6, further comprising the steps of providing said surface of said component to be one selected from the group consisting of polycarbonate, an elastomer, an acrylic material, and a molded transparency.

10. The plasma spray process for coating a surface of claim 6, further comprising the steps of providing said powder to be made from reclaimed glass powder.

11. A plasma spray coated surface component comprising:
a component formed of plastic having one or more surfaces; and
one or more coating layers adhered to said one or more surfaces of said component, wherein said coating is one selected from the group comprising glass and ceramic.

12. The plasma spray coated surface component of claim 11 wherein said component is polycarbonate material.

13. The plasma spray coated surface component of claim 11 wherein said component is metal material and not plastic.
